(19) United States
(12) Patent Application Publication
(10) Pub. No.: US 2023/0102874 A1
(43) Pub. Date: Mar. 30, 2023

(54) INSERTION ELEMENT FOR A PLASTIC FORMWORK PANEL FRAME

(71) Applicant: PERI SE, Weissenhorn (DE)

(72) Inventor: Wolfgang Span, Bellenberg (DE)

(73) Assignee: PERI SE, Weissenhorn (DE)

(21) Appl. No.: 17/760,194

(22) PCT Filed: Feb. 4, 2021
(86) PCT No.: PCT/EP2021/052626

§ 371 Date: Aug. 5, 2022

(30) Foreign Application Priority Data
Feb. 7, 2022 (DE) 10 2020 201 563.5

(51) Int. Cl. G06Q 10/20; E04G 9/05; E04G 17/00

(52) U.S. Cl. CPC G06Q 10/20; E04G 9/05; E04G 17/001

(57) ABSTRACT

Insert element for insertion into a cavity of a plastic formwork panel frame with a mounting for accommodating a read-out data memory.

### REFERENCE TO RELATED APPLICATIONS

The present application claims priority to German Patent Application No. 10 2020 201 563.5, filed Feb. 7, 2020, which is incorporated herein by reference in its entirety.

### FIELD OF INVENTION

The invention relates to formwork technology for the production of walls or ceilings in concrete construction. In particular, the invention relates to an insert element for insertion into a cavity of a plastic formwork panel frame, a plastic formwork panel frame with an insert element, a plurality of uses, a readout and maintenance system, a program element, and a computer-readable medium.

### TECHNICAL BACKGROUND

For the production of walls or ceilings in concrete construction, formwork panels are used which have a formwork panel frame that supports a formwork panel. Concrete can be poured between two such skins.

Panel frames and formwork panels are regularly maintained and, if necessary, replaced to ensure optimum quality of the wall and ceiling.

### SUMMARY

It is an object of the present invention to reduce the amount of maintenance and servicing required for panel frames and skins.

This object is solved by the features of the independent patent claims. Further embodiments of the invention will be apparent from the dependent patent claims and the following description of embodiments.

A first aspect of the present disclosure relates to an insert element for insertion into a cavity of a formwork panel frame, in particular a plastic formwork panel frame. The insert member includes a mounting configured to receive a readable data storage device.

The data memory can be a computer chip, for example in the form of an RFID chip, or an active transponder that can be read out wirelessly. This chip can be configured in particular for so-called geolocation. Geolocation software can be installed on the readout device in order to determine the location of the shuttering panel frame as accurately as possible with the aid of the IP address.

Also, the chip may have a sensor system that can measure, for example, the installation position of the insert element, the temperature of the concrete, the pressure acting on the formwork panel, the useful life or operating time of the formwork panel frame, or the number of concreting cycles.

In particular, the data stored on the readable data memory can be used to determine a suitable time for maintenance of the plastic formwork panel frame.

It may be envisaged that the energy storage of the chip and its sensor system can be charged via an energy supply interface when, for example, the formwork panel frame is stored for further use. In particular, a wireless energy supply interface could be provided for this purpose, for example of inductive design. However, it is also possible for the energy supply interface to be of a wired design, for example in the form of interface connections that are accessible via the cavity into which the insert element is inserted, at least when the shuttering panel is removed.

In particular, the outer contour of the insert element can be adapted to the inner contour of the cavity into which it is inserted, so that it can be held there in a form-fitting manner.

For example, the insert element has a lead-through such as a threaded rod, which is fastened to the formwork panel frame, for fixing the insert element in the cavity of the formwork panel frame.

This lead-through may, for example, be arranged centrally in the direction of the longitudinal extension of the insert element.

According to one embodiment, the insert element has a carrier in which the readable data memory is integrated, and which is attached to the mounting.

The mounting is designed, for example, in the form of a recess in a side wall of the insert element and has a rectangular cross section, so that the carrier can be inserted into the mounting.

The recess and/or the carrier may have a cross-section tapering in the longitudinal direction so that the carrier, which may be substantially cuboidal or plate-shaped, is jammed in the recess when it is pushed into the mounting and is thus securely fixed.

According to a further embodiment, the insert element has a rectangular or diamond-shaped cross-section with at least one rounded corner and at least one flattened corner, so that it can be inserted into the formwork panel frame only in a specific orientation relative to the cavity of the formwork panel frame.

Also, the insert element may have a cross-section that widens in the longitudinal direction so that the insert element jams into the cavity of the shuttering panel frame when inserted therein and is thus securely fixed.

The insert element can be designed to be hinged open and have a hinge for this purpose. Alternatively, the base body and the cover of the insert element are not connected to each other in the opened state.

Another aspect of the present disclosure relates to a plastic shuttering panel frame or, more generally, a shuttering panel frame, comprising an insert member described above and below.

Another aspect of the present disclosure relates to the use of a readable data storage device for incorporation into an insert element described above and below.

Another aspect of the present disclosure relates to the use of a readable data storage device for incorporation into a formwork panel frame.

In particular, the readable data memory may store product information about the shuttering panel frame and/or a shuttering panel held by the shuttering panel frame.

Another aspect of the present disclosure relates to a formwork panel readout and maintenance system comprising a mobile readout device configured to read out data from a data memory of a formwork panel frame. This mobile readout device can be, for example, a cell phone. There is further provided a control unit, which may be integrated in the cell phone or in a central processing unit, and which is configured to determine a time for maintenance of the shuttering panel frame based on the read-out data.

Another aspect of the present disclosure relates to a program element which, when executed on a readout and maintenance system, causes the readout and maintenance system to read out data of a data memory of a shuttering panel frame described above and to determine a suitable time for maintenance of the shuttering panel frame based on the read-out data.

Another aspect of the present disclosure relates to a computer-readable medium on which a program element described above is stored.

For example, the program element may be loaded and/or stored in a main memory of a data processing device, such as a data processor, wherein the data processing device may also be part of an embodiment of the present disclosure. This data processing device may be configured to perform method steps of the method described above. The data processing device may further be configured to automatically execute the computer program or method and/or execute input from a user. The program element may also be provided over a data network, such as the Internet, and downloaded from such a data network to the memory of the data processing device. The program element may also comprise an update to an existing program element, thereby enabling the existing computer program to execute the method described above, for example.

In particular, but not necessarily, the computer-readable medium may be a non-volatile medium particularly suitable for storing and/or distributing a computer program. The computer-readable storage medium may be a CD-ROM, a DVD-ROM, an optical storage medium, a solid-state medium, or the like, provided with or as part of other hardware. Additionally or alternatively, the computer-readable storage medium may be distributed or distributed in other forms, such as over a data network, such as the Internet or other wired or wireless telecommunications systems. In this respect, the computer-readable storage medium may take the form of one or more data packets, for example.

Embodiments of the present disclosure are described below. The illustrations in the figures are not schematic and are not to scale. If the same reference signs are used in the following description of figures, these describe the same or similar elements.

### BRIEF DESCRIPTION OF THE FIGURES

FIG. 1 shows an insert element according to an embodiment.

FIG. 2 shows a further view of the insert element of FIG. 1.

[symbol]

FIG. 3 shows a plastic formwork panel frame element of a plastic formwork panel frame with an insert element partially inserted therein.

FIG. 4 shows the frame element of FIG. 3 with a fully inserted insert element.

FIG. 5 shows a foldable insert element in the unfolded state.

FIG. 6 shows an opened insert element without hinge.

FIG. 7 shows the opened insert element of FIG. 6 with a carrier with integrated data storage.

FIG. 8 shows a plastic formwork panel frame with an insert element and a readout and maintenance system.

### DETAILED DESCRIPTION OF EMBODIMENTS

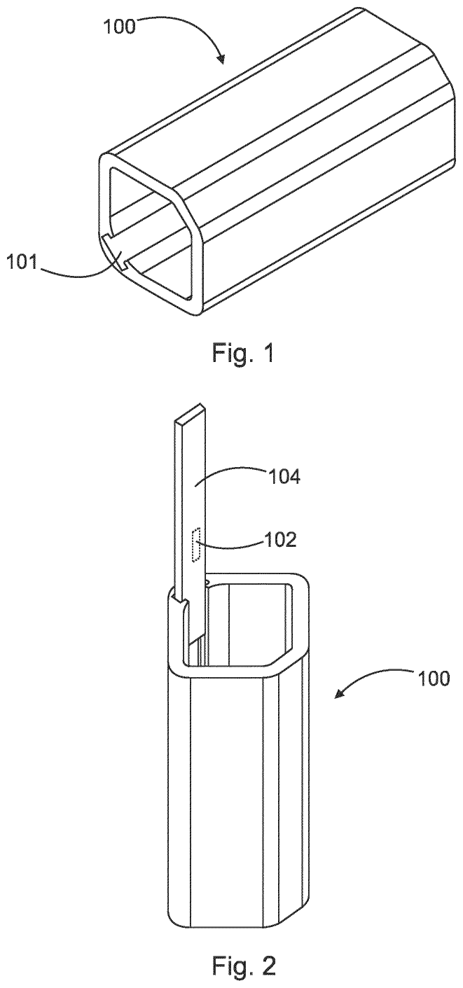

FIG. 1 shows an insert element 100 for insertion into a cavity of a panel frame, in particular a plastic formwork panel frame. The insert element 100, which may also be referred to as an inlay, has a mounting 101 for receiving a recognition means in the form of a readable data memory, which is typically mounted on or integrated in a carrier. The carrier may be inserted into the mounting 101.

The insert element 100 may be inserted into a cavity in a corner of a plastic¬formwork panel frame. Its shape (length, width, outer contour) is matched to the free spaces or cavities provided in the plastic formwork panel frame, so that it can be inserted there with a positive fit. The insert element 100 may be injection molded or 3D printed and is typically made of plastic.

A reception (mounting 101) is provided in the insert element 100 for receiving the carrier of a read-out data memory. For example, the mounting is slot-like so that the carrier can be inserted therein. The slot tapers slightly so that the carrier is held there in a form-fitting manner. Alternatively, a plug-in connection may be provided, an adhesive connection may be provided, or the readable data memory may be injected during manufacture of the insert element.

The insert element can be designed as a closed, bushing-like component whose outer contour is such that it can be inserted into the cavity in the plastic formwork panel frame and likewise held there in a form-fitting manner. The insert element and the plastic formwork panel frame can thus be connected with virtually no gaps.

The insert element sits, for example, between the ribs of the plastic shuttering panel frame in the area of the outer peripheral wall of the plastic shuttering panel frame, so that the shielding of the read-out data memory can be minimized. Alternatively, the readable data memory can also be arranged centrally in the plastic formwork panel frame.

The insert element is, for example, diamond-shaped or rectangular in cross-section. A projecting nose or ledge can be provided, which specifies a clear positioning of the insert element. For example, the nose or ledge may be located in the corner of the plastic formwork panel frame when the insert element is inserted into the cavity. For example, the readable data storage device is located in the region of this outer corner.

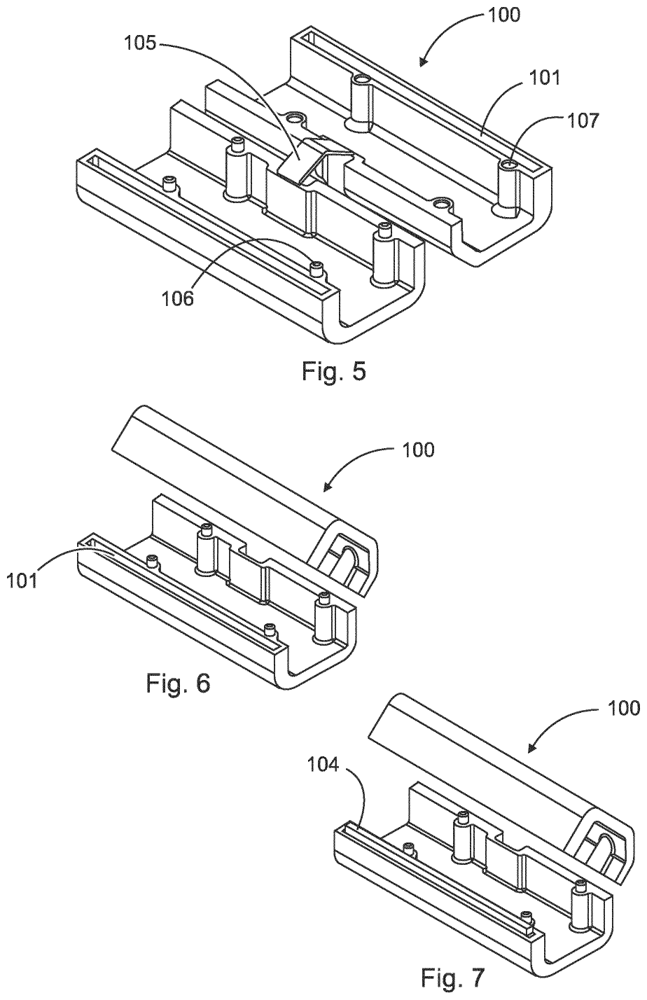

Alternatively, the insert element 100 is configured to be hinged open, as shown in FIGS. 5, 6 and 7. In this case, the readable data memory can be inserted in the unfolded state. The insert element is folded and closed prior to insertion into the plastic formwork panel frame.

The readable data memory can be designed as an RFID chip. Alternatively, it may be designed as an active transponder for geolocation, position and temperature measurement. It can have a Bluetooth module and other sensor technology. It may also be configured to use Narrow Band IoT (NBIoT) for data transmission.

In particular, the readable data store may have sensor technology to detect the position, temperature, service life, slope, and/or pressure of the concrete. From this data, an optimal time for maintenance can be determined.

FIG. 2 shows the insert element 100 of FIG. 1, with a partially inserted carrier 104 in which a readable data memory 102 is integrated. The carrier is cuboid or plate-shaped and wedges into the recess when pushed in, so that it is firmly fixed there.

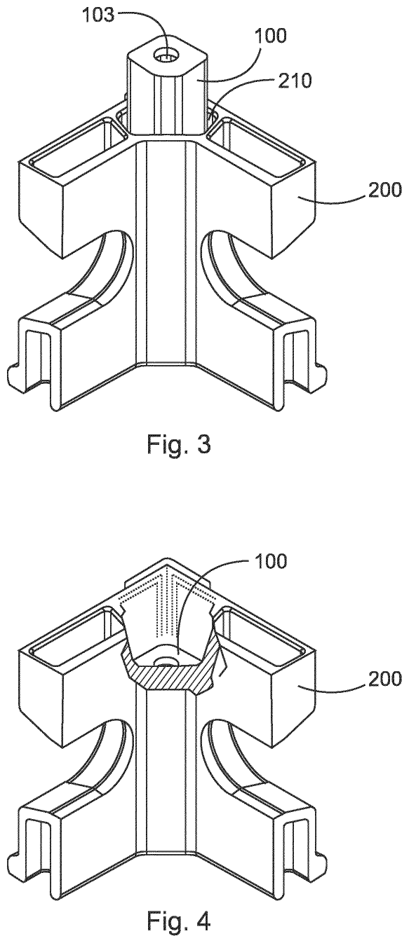

FIG. 3 shows a plastic formwork panel frame element of a plastic formwork panel frame 200, in the cavity 210 of which, located in a corner, an insert element 100 is partially inserted. The insert element 100 has a bushing 103 through which a threaded rod of the plastic formwork panel frame 200 can be passed in order to lock the insert element.

FIG. 4 shows the plastic formwork panel frame 200 of FIG. 3 with the insert element 100 fully inserted. As can be seen in this figure, the insert element 100 is shorter than the cavity into which it is inserted.

The plastic formwork panel frame 200 has, for example, a plurality of cavities and/or ribs resulting from the structural requirements of the panel. These are suitable for reception of the support or insert element. The insert element is inserted between the ribs and held positively. The insert elements with the read-out data memories are inserted, for example, in diagonally opposite corners of the plastic formwork panel frame, so that at least two insert elements (and data memories) are always available per plastic formwork panel frame. This can simplify the readout of the data memories and minimize shielding effects.

For example, when the readable data memory is centrally located on the perimeter wall, two to four readable data memories are provided, such as one in the center of each side portion of the plastic formwork panel frame, and/or one in the center, to simplify readout. In particular, placing the data memory in a corner of the plastic formwork panel frame is advantageous because it can be easily located by the user.

By reading out the data memory, the formwork can be easily identified, especially if the data memory can be read out by means of a cell phone or the like. Using the read-out data, for example, services such as logistics, maintenance, inventory analysis, BIM, integration into formwork planning, verification of correct assembling can be provided, product information can be retrieved and tracking of the plastic formwork panel frame can be performed. The data can also be transferred and displayed in a customer app. Appropriate readers and software are provided for this purpose.

The readable data memory can, for example, be a dual frequency transponder used in the UHF and HF band ranges.

The data memory is installed, for example, by dismantling the formwork panel, inserting the insert element into a cavity in the corner of the plastic panel frame, followed by mounting the formwork panel. Thus, the insert element can be retrofitted in the area for already delivered plastic formwork panel frames.

The factory installation of the readable data memory in the plastic formwork panel frame ensures that the plastic formwork panel frame can be uniquely and easily identified. The ID serial number of the data memory or plastic formwork panel frame stored in the data memory can then be used for further processing of the data. It may be provided that the EPC code on the chip is identical for each chip installed in the panel frame. However, the serial number may vary, for example, due to changing time stamps from data storage manufacturing.

FIG. 5 shows an insert element 100 in a hinged embodiment with a hinge 105 connecting the upper and lower portions. The lower portion includes a plurality of spot pins 106 that engage corresponding sockets 107 of the upper portion when the latter is closed.

FIG. 6 shows a similar embodiment, but without a hinge. A recess (“mounting” 101) is provided in the side wall of the lower part, into which the carrier of the read-out data memory can be inserted.

FIG. 7 shows the embodiment of FIG. 6 with the carrier 104 inserted.

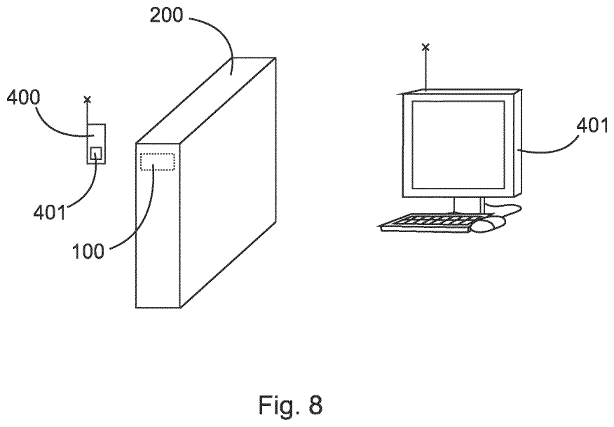

FIG. 8 shows a readout and maintenance system for reading out and maintaining a plastic formwork panel frame 200. Several insert elements are inserted in the panel frame 200, wherein only one of these insert elements 100 is shown in FIG. 9.

The readout and maintenance system comprises a mobile readout device 400, configured to read out data stored on the data memory of the insert element 100. Furthermore, the mobile readout device 400 comprises a control unit 401, which can evaluate this data.

Alternatively or additionally, it can be provided that the read-out data is transmitted via a radio interface of the mobile read-out device 400 to a central control unit 401, for example a server or a cloud, in order to be evaluated there. From this data, for example, a suitable time for maintenance of the plastic formwork panel frame or a formwork panel held by it can be calculated. This time can then be transmitted to a maintenance technician so that he can carry out the maintenance in a timely manner.

Supplementally, it should be noted that “comprising” and “comprising” do not exclude other elements or steps, and the indefinite articles “one” or “a” do not exclude a plurality. It should further be noted that features or steps that have been described with reference to any of the above embodiments may also be used in combination with other features or steps of other embodiments described above. Reference signs in the claims are not to be regarded as limitations.

1. Insert element (100) for insertion into a cavity of a plastic formwork panel frame (200), comprising:
a mounting (101) for receiving a readable data memory (102).

2. Insert element (100) according to claim 1, comprising:
a bushing (103) for a threaded rod for fixing the insert element in the cavity of the plastic formwork panel frame (200).

3. Insert element (100) according to any of the preceding claims, comprising:
A carrier (104) having a readable data memory (102) attached to the mounting (101).

4. Insert element (100) according to claim 3,
wherein the mounting (101) is in the form of a recess in a side wall of the insert element and has a rectangular cross-section so that the carrier (104) can be inserted into the mounting.

5. Insert element (100) according to one of claim 3 or 4,
wherein the recess has a cross-section tapering in the longitudinal direction, such that the carrier (104), which is cuboidal or plate-shaped, jams when inserted into the mounting.

6. Insert element (100) according to any one of the preceding claims,
wherein the insert element has a rectangular or rhombic cross-section with at least one rounded corner and one flattened corner, so that it can only be inserted into the cavity of the plastic formwork panel frame (200) in a certain orientation relative thereto.

7. Insert element (100) according to any one of the preceding claims,
wherein the insert element has a cross-section which widens in the longitudinal direction, so that the insert element jams when inserted into the cavity of the plastic formwork panel frame (200).

8. Insert element (100) according to any one of the preceding claims,
wherein the insert element is designed to be hinged open.

9. Formwork panel frame (200) with an insert element (100) according to any one of the preceding claims.

10. Use of a read-out data memory (102) for installation in an insert element (100) according to any one of claims 1 to 8.

11. Use of a readable data memory (102) for installation in a shuttering panel frame (200) according to claim 9.

12. Use according to claim 10 or 11,
wherein product information about the shuttering panel frame (200) or a shuttering panel (201) is stored on the readable data memory (102).

13. A formwork panel readout and/or maintenance system, comprising:
a mobile readout device (400), adapted to read out data of a data memory (102) of a plastic formwork panel frame (200);
a control unit (401) configured to determine a timing for maintenance of the plastic formwork panel frame (200) based on the read-out data.

14. Program element that, when executed on a readout and maintenance system (300), causes the readout and maintenance system to perform the following steps:
reading data from a data storage device (102) of a plastic formwork panel frame (200);
determining a time for maintenance of the plastic formwork panel frame (200) based on the readout data.

15. Computer-readable medium on which is stored a program element according to claim 14.
